(19) United States
(12) Patent Application Publication
(10) Pub. No.: US 2026/0235149 A1
(43) Pub. Date: Aug. 13, 2026

(54) FOUR-FRAME CONNECTOR AND DISPLAY STAND FOR DISPLAY STANDS

(71) Applicant: Lei Zhao, Baldwin Park, CA (US)

(72) Inventor: Lei Zhao, Baldwin Park, CA (US)

(21) Appl. No.: 19/160,441

(22) PCT Filed: Mar. 6, 2024
(86) PCT No.: PCT/US2024/018749

§ 371 Date: Aug. 27, 2025

(30) Foreign Application Priority Data
Mar. 29, 2023 (CN) 202320659156.5

(51) Int. Cl. F16B 12/44; A47F 5/01

(52) U.S. Cl. CPC F16B 12/44; A47F 5/01; F16B 2012/446

(57) ABSTRACT

This present application provides a four-frame connector for a display stand, including a support base and three connecting columns extending from one side of the support base. The support base includes a first supporting part and a second supporting part connected to the first supporting part. The second supporting part is fixedly connected to the middle part of the first supporting part. The connecting columns include two first connecting columns set on the first supporting part and extending in the same direction on both sides of the second supporting part, and a second connecting column set on one side of the second supporting part. Each of the three connecting columns includes a columnar body and a limit strip protruding radially from the column body. This four-frame connector for the display stand can achieve connection of frames at specific locations, offering better connection effects, a lighter structure, and lower cost.

### CROSS-REFERENCES TO RELATED APPLICATIONS

This application claims priority on CN application No. 219327704 filed on Mar. 29, 2023, the entire contents of which are hereby incorporated by reference.

### FIELD OF THE INVENTION

This present invention relates to a four-frame connector and display stand for display stands.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Existing display stand frames are either integrally formed or connected by connectors. However, connections made solely by connectors can still easily become loose, and even slight shaking can cause insecure connections, significantly impacting the user experience during display.

In view of this, it is necessary to improve the existing four-frame connectors for display stands to solve the aforementioned problems.

### SUMMARY

The purpose of this present invention is to provide a four-frame connector for a display stand to address the issue of insecure connections in existing display stands.

To achieve this purpose, this present invention provides a four-frame connector for a display stand, which includes a support base and three connecting columns extending from one side of the support base. The support base comprises a first supporting part and a second supporting part connected to the first supporting part. The second supporting part is fixedly connected to the middle part of the first supporting part. The connecting columns include two first connecting columns set on the first supporting part and extending in the same direction on both sides of the second supporting part, and a second connecting column set on one side of the second supporting part. Each of the connecting columns includes a columnar body and a limit strip protruding radially from the said column body.

In another aspect, each connecting column has four limit strips.

In another aspect, the end of the connecting column away from the support base is provided with a chamfer.

In another aspect, the support base is penetrated by three positioning holes, two of which are located at the ends of the first supporting part, and another one of the three positioning holes is located at the end of the second supporting part away from the first supporting part.

In another aspect, the positioning holes include a round hole and a plurality of limit holes protruding radially outward from the round hole, with the positioning holes being petal-shaped.

In another aspect, the two first connecting columns are located between the two positioning holes on the first supporting part.

In another aspect, the second connecting column is located between the positioning hole on the second supporting part and the first supporting part.

In another aspect, the first supporting part has multiple first grooves on the side away from the first connecting column, and similarly, the second supporting part has multiple second grooves on the side away from the second connecting column.

In another aspect, the edges of the second supporting part have multiple buckle slots, which are on the same side as the second connecting column.

This present invention also provides a display stand, which includes multiple interconnected frames and the aforementioned four-frame connectors for the display stand. These connectors are used to connect four adjacent frames.

The beneficial effect of this present invention is that the four-frame connector for the display stand can achieve connection of frames at specific locations, offering better connection effects, a lighter structure, and lower cost.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 shows a schematic diagram of a structure of a display stand.

FIG. 2 shows an enlarged view of area A in FIG. 1.

FIG. 3 shows a schematic diagram of a three-frame connector of the display stand.

FIG. 4 shows a schematic diagram of the three-frame connector of the display stand from another angle.

FIG. 5 shows an enlarged view of area B in FIG. 1.

FIG. 6 shows a schematic diagram of a four-frame connector of the display stand.

FIG. 7 shows a schematic diagram of the four-frame connector of the display stand from another angle.

FIG. 8 shows an enlarged view of area C in FIG. 1.

FIG. 9 shows a schematic diagram of a corner connector of the display stand.

FIG. 10 shows a schematic diagram of the corner connector of the display stand from another angle.

FIG. 11 shows a schematic diagram of a supporting frame of the display stand.

FIG. 12 shows an enlarged view of area D in FIG. 1.

FIG. 13 shows a schematic diagram of a fixing component for the display stand.

FIG. 14 shows an enlarged view of area E in FIG. 1.

FIG. 15 shows a schematic diagram of a supporting component for the display stand.

Like reference numerals refer to like parts throughout the various views of the drawings.

### DETAILED DESCRIPTION OF THE INVENTION

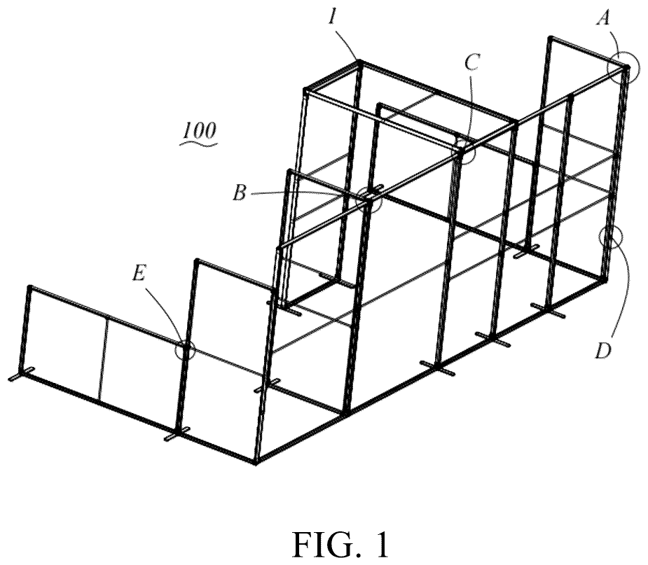

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

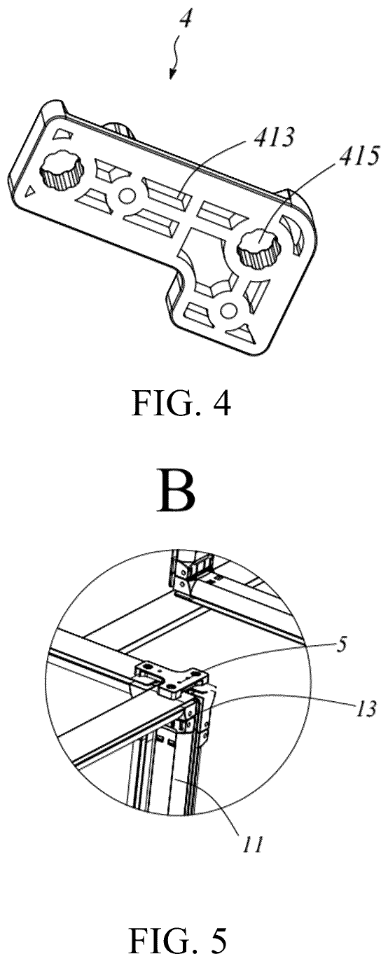

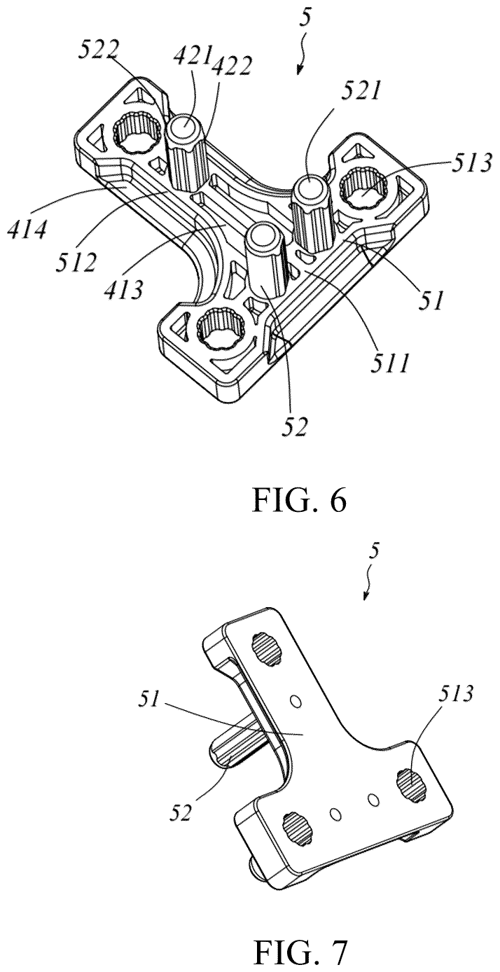

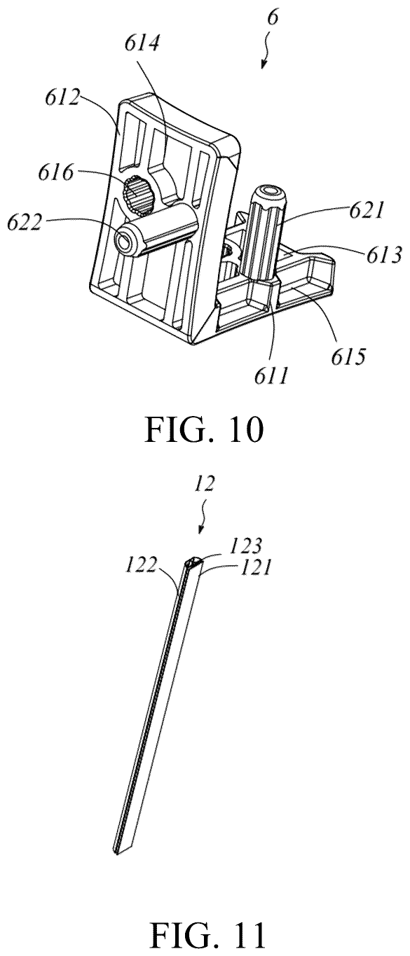

As shown in FIGS. 1 to 15, the display stand 100 of the present application includes a frame 1, fixing components 2 for the display stand, supporting components 3 for the display stand, display components, rod-shaped frames set at the edges of the display components, three-frame connectors 4 for the display stand, four-frame connectors 5 for the display stand, and corner connectors 6 for the display stand.

The display components can be posters or banners, with the rod-shaped frames used to support these display components. The fixing components 2 and supporting components 3 for the display stand are used to fix and support the rod-shaped frames, thereby securing and supporting the display components.

The frame 1 includes connecting frames 11, supporting frames 12, and connectors 13 for connecting adjacent connecting frames 11. The fixing components 2 for the display stand are clamped onto the supporting frames 12, with the connecting frames 11 forming the main structure of the frame 1.

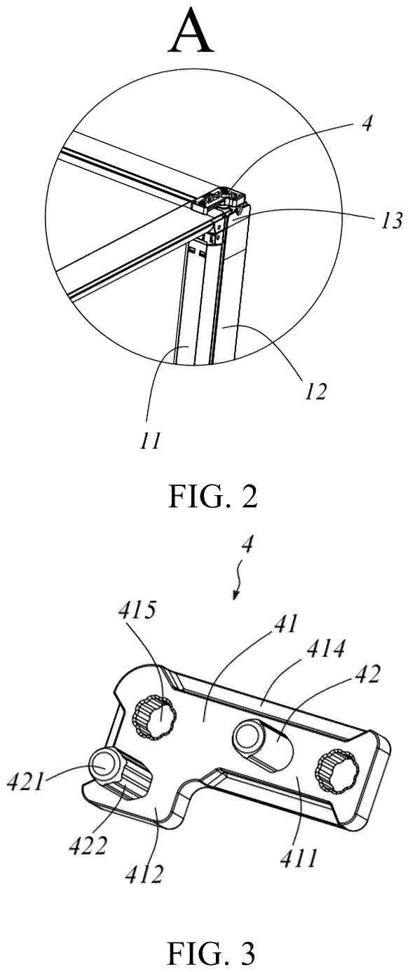

As shown in FIGS. 2 to 4, the three-frame connectors 4 for the display stand are used to connect three adjacent edge frames, specifically, to connect parts of the connecting frames 11 that are perpendicular to each other. The three-frame connectors 4 include a first support base 41 and at least two positioning columns 42 extending from one end of the first support base 41.

The first support base 41 includes a first connecting part 411 extending in one direction and a second connecting part 412 connected to the first connecting part 411 and extending in another direction.

The first support base 41 has multiple grooves 413 on the side away from the positioning columns 42, recessed inward. The inclusion of grooves 413 can save material, reduce weight, and further reduce production and transportation costs.

The first support base 41 has multiple buckle slots 414 on the side with the positioning columns 42, set at the edge of the first support base 41. The buckle slots 414 facilitate manual gripping by the user, making installation and disassembly easier.

At least two positioning columns 42 are respectively set on the first connecting part 411 and the second connecting part 412. The positioning columns 42 include a columnar body 421 and limit strips 422 protruding radially from the body 421.

Each positioning column 42 has four limit strips 422. The positioning columns 42 are used to connect with corresponding insertion holes on the connecting frames 11 and connectors 13, which have limit slots for cooperating with the limit strips 422. When the positioning columns 42 are inserted into the insertion holes, the limit strips 422 engage with the limit slots, preventing the three-frame connectors 4 from rotating relative to the frame 1. The end of the positioning columns 42 away from the first support base 41 is provided with a chamfer, facilitating insertion into the insertion holes.

The first support base 41 is penetrated by two first positioning holes 415. The first positioning holes 415 include a round hole and a plurality of limit holes protruding radially outward from the round hole, with the first positioning holes 415 being petal-shaped. The connecting frames 11 and connectors 13 have corresponding positioning components, which are used to engage and fit with the first positioning holes 415. It should be noted that the height of the positioning components is less than the thickness of the first support base 41. The petal-shaped first positioning holes 415 can restrict the rotation of the positioning components and the first positioning holes 415.

The length of the first connecting part 411 is longer than the second connecting part 412, with two first positioning holes 415 set at both ends of the first connecting part 411. The positioning columns 42 on the first connecting part 411 are located between the two first positioning holes 415.

The number of positioning columns 42 is two, with one positioning column 42 set on each of the first connecting part 411 and the second connecting part 412.

Two perpendicular connecting frames 11 are connected through connectors 13, with one connecting frame 11 connected to a third connecting frame 11 through another connector 13. The two positioning columns 42 are respectively inserted into the insertion holes of the corresponding two connectors 13, with the first positioning holes 415 cooperating with the positioning components on the corresponding connectors 13, thereby achieving the effect of connecting three connecting frames 11.

As shown in FIGS. 5 to 7, the four-frame connectors 5 for the display stand include a second support base 51 and three connecting columns 52 extending from one side of the second support base 51. The connecting columns 52 of the four-frame connectors 5 for the display stand have the same function as the positioning columns 42 of the three-frame connectors 4, just with a different name.

The second support base 51 includes a first supporting part 511 and a second supporting part 512 connected to the first supporting part 511. The second supporting part 512 is fixedly connected to the middle part of the first supporting part 511, making the second support base 51 T-shaped in its entirety.

The first supporting part 511 of the second support base 51 has multiple grooves 413 on the side away from the first connecting column 521, and similarly, the second supporting part 512 has multiple grooves 413 on the side away from the second connecting column 522. The inclusion of grooves 413 can save material, reduce weight, and further decrease production and transportation costs.

The edge of the second supporting part 512 is equipped with multiple buckle slots 414, which are on the same side as the second connecting column 522. These buckle slots 414 facilitate manual gripping by the user, making installation and disassembly easier.

The connecting columns 52 include two first connecting columns 521 set on the first supporting part 511 and extending in the same direction on both sides of the second supporting part 512, and a second connecting column 522 set on one side of the second supporting part 512.

Each of the connecting columns 52 includes a columnar body 421 and limit strips 422 protruding radially from the body 421. Each connecting column 52 has four limit strips 422. The connecting columns 52 are used to connect with corresponding insertion holes on the connecting frames 11 and connectors 13, which have limit slots for cooperating with the limit strips 422. When the connecting columns 52 are inserted into the insertion holes, the limit strips 422 engage with the limit slots, thereby preventing the four-frame connectors 5 from rotating relative to the frame 1.

The end of the connecting columns 52 away from the second support base 51 is provided with a chamfer, facilitating insertion into the insertion holes.

The second support base 51 is penetrated by three second positioning holes 513, two of which are located at the ends of the first supporting part 511, and another one of the three second positioning holes 513 is located at the end of the second supporting part 512, far from the first supporting part 511.

The second positioning holes 513 include a round hole and a plurality of limit holes protruding radially outward from the round hole, with the second positioning holes 513 being petal-shaped.

The two first connecting columns 521 are located between the two second positioning holes 513 on the first supporting part 511. The second connecting column 522 is located between the second positioning hole 513 on the second supporting part 512 and the first supporting part 511.

Positioning components are correspondingly set on the connecting frames 11 and connectors 13. These positioning components are used to engage and fit with the second positioning holes 513. It should be noted that the height of the positioning components is less than the thickness of the second support base 51.

The second support base 51 and the second positioning holes 513, as described in the claims, are the support base and positioning holes, respectively.

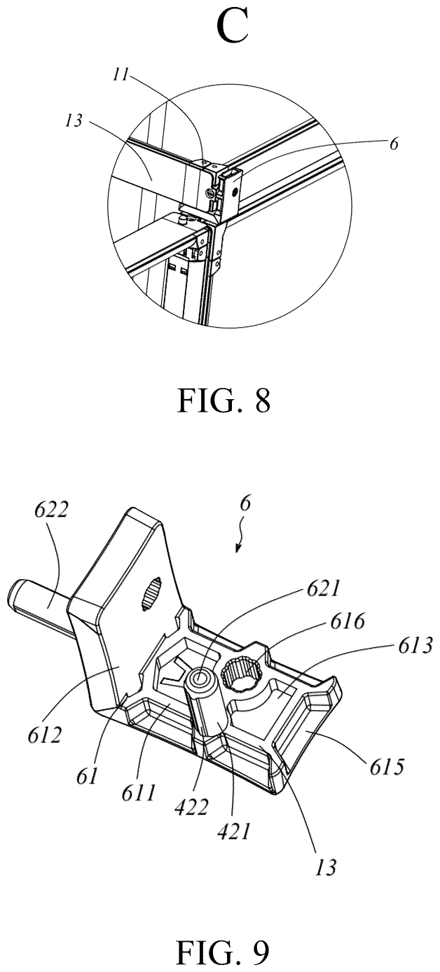

As shown in FIGS. 8 to 10, the four-frame connectors 5 for the display stand are used to connect four connecting frames 11 of the frame 1. Two of the connecting frames 11 are in the same line, the third connecting frame 11 is perpendicular to the first two connecting frames 11, and all three connecting frames 11 are in the same plane, forming a T-shape, with the fourth connecting frame 11 perpendicular to the plane of the first three connecting frames 11. The three connecting frames 11 in the same plane are connected to another connecting frame 11 at the joint through connectors 13.

The two first connecting columns 521 are respectively inserted into the insertion holes of the corresponding two connecting frames 11 on the same line, and the second connecting column 522 is inserted into the insertion hole of the third connecting frame 11. The second positioning holes 513 cooperate with the positioning components on the corresponding connectors 13, thereby achieving the effect of connecting four connecting frames 11.

The corner connectors 6 for the display stand include a third support base 61 and two insertion columns 62 set on the third support base 61.

The third support base 61 includes a first supporting member 611 extending along one plane and a second supporting member 612 extending perpendicularly to the plane of the first supporting member 611. One end of the first supporting member 611 and the second supporting member 612 are fixedly connected.

The first supporting member 611 has a first insertion column 621 on one side, with an inwardly recessed surface forming a first clearance slot 613 and an edge forming a gripping slot 615. The second supporting member 612, which has a second insertion column 622, has an inwardly recessed surface forming a second clearance slot 614. The inclusion of the first and second clearance slots 613 and 614 can save material, reduce weight, and further decrease production and transportation costs.

The gripping slot 615 facilitates manual gripping by the user, making installation and disassembly easier.

The insertion columns 62 include a first insertion column 621 set on the first supporting member 611 and parallel to the plane of the second supporting member 612, and a second insertion column 622 set on the second supporting member 612 and parallel to the plane of the first supporting member 611. The first insertion column 621 extends in the same direction as the second supporting member 612, while the second insertion column 622 extends in the opposite direction as the first supporting member 611.

Both the first insertion column 621 and the second insertion column 622 include a columnar body 421 and limit strips 422 protruding radially from the body 421. Each insertion column 62 has four limit strips 422. The insertion columns 62 are used to connect with corresponding insertion holes on the connecting frames 11 and connectors 13, which have limit slots for cooperating with the limit strips 422. When the connecting columns 52 are inserted into the insertion holes, the limit strips 422 engage with the limit slots, thereby preventing the four-frame connectors 5 from rotating relative to the frame 1.

The first insertion column 621, located away from the first supporting member 611, and the second insertion column 622, located away from the second supporting member 612, both have chamfers. These chamfers facilitate the insertion of the positioning columns 42 into the insertion holes.

Both the first supporting member 611 and the second supporting member 612 are penetrated by third positioning holes 616. These third positioning holes 616 include a round hole and a plurality of limit holes protruding radially outward from the round hole, with the positioning holes being petal-shaped. Positioning components, correspondingly set on the connecting frames 11 and connectors 13, are used to engage with the third positioning holes 616. It should be noted that the height of the positioning components is less than the thickness of the third support base 61.

The corner connector 6 for the display stand is used to connect two connecting frames 11 on adjacent planes. The second supporting member 612 is located between the two connecting frames 11. The second insertion column 622 is inserted into the insertion hole of the corresponding connecting frame 11 on one side, and the first supporting member 611 is positioned at the side edge of the connecting frame 11 on the other side, with the first insertion column 621 inserted into the insertion hole of the connecting frame 11 on the opposite side. The third positioning holes 616 cooperate with the positioning components on the corresponding connectors 13, thereby achieving the effect of connecting two connecting frames 11 on different planes. The positioning of the second supporting member 612 between the two connecting frames 11 enhances the clamping effect, making it less likely to come loose.

As shown in FIG. 11, the supporting frame 12 includes a first support plate 121 extending in one direction, a second support plate 122 set at a distance from the first support plate 121, and a connecting plate 123 for connecting the first and second support plates 121 and 122. The width of the connecting plate 123 is smaller than that of the first support plate 121.

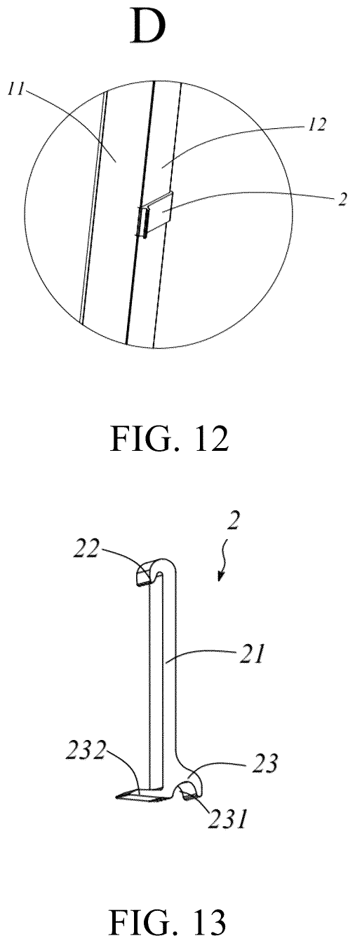

As shown in FIGS. 12 and 13, the fixing component 2 for the display stand includes a main body plate 21, a fixing hook 22 set at one end of the main body plate 21 and extending perpendicularly from one side of the main body plate 21, a clamping part 23 set at the other end of the main body plate 21 and extending perpendicularly from the opposite side of the main body plate 21, and a limit plate 24.

The clamping part 23 has a semi-cylindrical clamping slot 231. The rod-shaped frame is clamped in the clamping slot 231.

The limit plate 24 extends from the end of the main body plate 21 away from the fixing hook 22 and is perpendicular to the main body plate 21.

The limit plate 24 extends towards the end away from the clamping part 23. The first support plate 121 is clamped between the fixing hook 22 and the limit plate 24. The end of the limit plate 24 away from the main body plate 21 has a guiding part, which makes it easier for the first support plate 121 to be clamped between the limit plate 24 and the fixing hook 22.

The fixing hook 22 extends towards the limit plate 24 from the end away from the main body plate 21, and the first support plate 121 is clamped inside the fixing hook 22.

The frame 1 forms a quadrilateral, and the fixing component 2 for the display stand is fixed on the supporting frame 12, with the opening of the clamping slot 231 facing the frame 1 on the opposite side. The rod-shaped frame is clamped in the clamping slot 231 to fix the display components on the frame 1. In this embodiment, multiple fixing components 2 can be fixed on a single supporting frame 12 to improve the fixation of the display components.

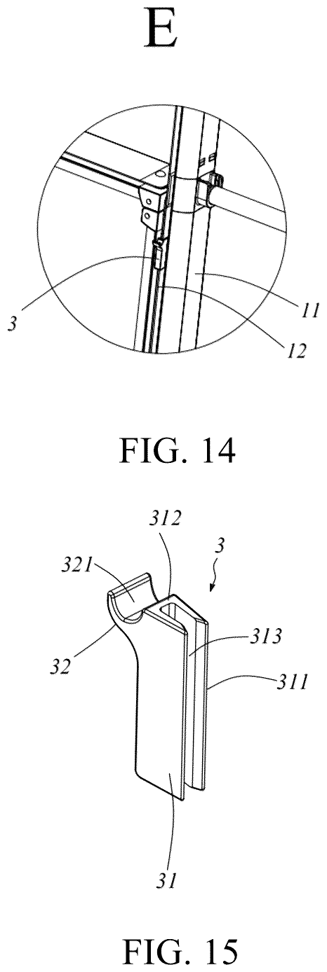

As shown in FIGS. 14 and 15, the supporting component 3 for the display stand includes a clamping part 31 and a support rod part 32.

The clamping part 31 includes two clamping plates 311 set at a distance from each other and a fixing plate 312 for connecting the two clamping plates 311. The clamping plates 311 and the fixing plate 312 form a clamping slot 313. The support rod part 32 extends from the side of the fixing plate 312 away from the clamping plates 311 and forms a semi-cylindrical clamping slot 321.

The extension direction of the clamping slot 321 is perpendicular to the extension direction of the clamping slot 313.

The distance between the two clamping plates 311 gradually decreases from the end near the fixing plate 312 to the end away from the fixing plate 312. The first support plate 121 is clamped in the clamping slot 313 of the supporting component 3 for the display stand. Due to the smaller opening end of the clamping slot 313, the first support plate 121 is more firmly clamped.

The end of the clamping plates 311 away from the fixing plate 312 has a guiding part, set near the side of the clamping slot 313. The guiding part makes it easier for the first support plate 121 to be inserted into the clamping slot 313.

The frame 1 forms a quadrilateral, and the supporting component 3 for the display stand is fixed on the supporting frame 12, with the opening of the clamping slot 321 facing the frame 1 on the opposite side. The rod-shaped frame is clamped in the clamping slot 321 to fix the display components on the frame 1. In this embodiment, multiple supporting components 3 can be fixed on a single supporting frame 12 to improve the fixation of the display components.

The four-frame connector 5 for the display stand of the present application can achieve the connection of frames 1 at specific locations, offering better connection effects, a lighter structure, and lower cost.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A four-frame connector for a display stand, comprising:
a support base; and
a plurality of connecting columns extending from one side of the support base, wherein
the support base includes a first supporting part and a second supporting part connected to the first supporting part,
the second supporting part is fixedly connected to a middle part of the first supporting part,
the plurality of connecting columns includes:
two first connecting columns are set on the first support part, located on both sides of the second support part, and they extend in the same direction, and
a second connecting column set on one side of the second supporting part, and
the plurality of connecting columns has a columnar body and at least one limit strip protruding radially from the column body.

2. The four-frame connector for the display stand according to claim 1, wherein four limit strips, including the at least one limit strip, are provided on each of the plurality of connecting columns.

3. The four-frame connector for the display stand according to claim 1, wherein an end of each of the plurality of connecting columns away from the support base is provided with a chamfer.

4. The four-frame connector for the display stand according to claim 1, wherein the support base is penetrated by three positioning holes, two of the three positioning holes are located at two ends of the first supporting part, and another one of the three positioning holes is located at an end of the second supporting part away from the first supporting part.

5. The four-frame connector for the display stand according to claim 4, wherein each of the three positioning holes includes a round hole and a plurality of limit holes protruding radially outward from the round hole, the three positioning holes being petal-shaped.

6. The four-frame connector for the display stand according to claim 4, wherein the two first connecting columns are located between the two of the three positioning holes on the first support part.

7. The four-frame connector for the display stand according to claim 4, wherein the second connecting column is located between the other one of the three positioning holes and the first supporting part.

8. The four-frame connector for the display stand according to claim 1, wherein the first supporting part has multiple first grooves on a side away from the two first connecting columns, and the second supporting part has multiple second grooves on a side away from the second connecting column.

9. The four-frame connector for the display stand according to claim 1, wherein an edge of the second supporting part has multiple buckle slots, which are on the same side as the second connecting column.

10. A display stand, wherein the display stand includes multiple interconnected frames and the four-frame connectors for the display stand according to claim 1, the display stand four-frame connectors being used to connect four adjacent frames.
